(19) United States
(12) Patent Application Publication
(10) Pub. No.: US 2011/0043544 A1
(43) Pub. Date: Feb. 24, 2011

(54) IMAGE DISPLAY DEVICE

(75) Inventors: Norihiro NAKAMURA, Mobara (JP); Hajime AKIMOTO, Kokubunji (JP); Junichi YOKOYAMA, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/856,777

(22) Filed: Aug. 16, 2010

(30) Foreign Application Priority Data
Aug. 18, 2009 (JP) 2009-189464

(51) Int. Cl. G09G 5/10

(52) U.S. Cl. 345/690

(57) ABSTRACT

Provided is an image display device, in which light emission period control signals are applied to a plurality of pixels holding voltages based on grayscale values, to emit from light emitting elements. During a horizontal synchronizing period, an active period of each of the light emission period control signals is divided into two periods. A start of one of the divisional periods coincides with a start of the horizontal synchronizing signal. An end of the other divisional period coincides with an end of the horizontal synchronizing signal. The active periods of the light emission period control signals (G) and (B) are equal to or larger than 80% of the active period of the light emission period control signal (R). An active period of a light emission control signal is synchronized with the light emission period control signal (R).

### CROSS-REFERENCE TO RELATED APPLICATION

The present application claims priority from Japanese application JP 2009-189464 filed on Aug. 18, 2009, the content of which is hereby incorporated by reference into this application.

### BACKGROUND OF THE INVENTION

1. Field of the Invention

The present invention relates to an image display device, and more particularly, to an image display device in which light emission period control voltages, which are the voltages of the light emission period control signal, are applied to a plurality of pixels that hold voltages based on grayscale values, and the light emitting elements which are self-emitters emit to display an image.

2. Description of the Related Art

In recent years, an image display device using an organic light emitting diode which is a self-emitter (hereinafter referred to as “organic EL display device”) has entered the practical stage. Unlike a conventional liquid crystal display device, the organic EL display device uses the self-emitter and thus is excellent in visibility and response speed. In addition, the organic EL display device does not require an auxiliary illumination device, for example, a backlight, and hence further thinning may be achieved.

As an example of the organic EL display device described above, Japanese Patent Application Laid-open No. 2003-122301 discloses an organic EL display device of a so-called clamped inverter (CI) drive type in which light emission period control voltages are applied to a plurality of pixels having storage capacitors keeping voltages based on grayscale values, to thereby emit light from organic EL elements. Further, Japanese Patent Application Laid-open No. 2008-33358 and Japanese Patent Application Laid-open No. 2006-119242 disclose organic EL display device.

### SUMMARY OF THE INVENTION

In order to prevent the degradation of the organic EL element which is the self-emitter and reduce power consumption in the organic EL display device, it is conceivable to perform low-luminance display based on ambient environments (for example, indoor use). However, when low-luminance display is performed, a contrast reduces, and hence it is likely to reduce display quality.

The present invention has been made in view of the circumstances described above. An object of the present invention is to provide an image display device of which a contrast is increased to improve display quality.

An image display device according to the present invention includes: a plurality of pixels which hold voltages based on grayscale values and each include: a light emitting element for emitting light for display when a light emission period control voltage which is a voltage of a light emission period control signal is applied to corresponding one of the plurality of pixels; a light emitting element driving transistor which operates as a switch for supplying a current based on corresponding one of the grayscale values in response to applying the light emission period control voltage; and a light emission control switch transistor which electrically connects between the light emitting element and the light emitting element driving transistor; a light emission period control signal driving section for controlling the light emitting element driving transistor; and a gate signal driving section for generating a light emission control signal to be input to a gate line of the light emission control switch transistor, wherein the gate signal driving section synchronizes the light emission control signal with the light emission period control signal.

Further, in the image display device according to the present invention: each of the plurality of pixels may include a plurality of the light emitting elements having different light emission colors; the plurality of the light emitting elements may have different application periods of the light emission period control voltage; and the gate signal driving section may synchronize the light emission control signal with the light emission period control signal having a maximum application period among the application periods of the light emission period control voltage.

Further, in the image display device according to the present invention, the light emission period control signal driving section may control the light emission period control signal to synchronize an end of an application period of the light emission period control voltage with an end of a horizontal synchronizing signal.

Further, in the image display device according to the present invention, the light emission period control signal driving section may control the light emission period control signal to match a center of an application period of the light emission period control voltage with a center of a horizontal synchronizing signal.

Further, in the image display device according to the present invention, the light emission period control signal driving section may divide an application period of the light emission period control voltage into a plurality of application periods.

Further, in the image display device according to the present invention, the light emission period control signal driving section may divide the application period of the light emission period control voltage into a first application period and a second application period, synchronize a start of the first application period with a start of a horizontal synchronizing signal for display on the image display device, and synchronize an end of the second application period with an end of the horizontal synchronizing signal.

Further, in the image display device according to the present invention: each of the plurality of pixels may include a plurality of the light emitting elements having different light emission colors; the plurality of the light emitting elements may have different application periods of the light emission period control voltage; and the light emission period control signal driving section may control application periods for light emitting elements other than a light emitting element having a maximum application period among the application periods so as to an application period equal to or larger than a predetermined percentage of the maximum application period.

Further, in the image display device according to the present invention, the predetermined percentage may be 80%.

### BRIEF DESCRIPTION OF THE DRAWINGS

In the accompanying drawings:

FIG. 1 is a diagram illustrating an organic EL display device according to a first embodiment of the present invention;

FIG. 2 is a schematic diagram illustrating a thin film transistor (TFT) substrate illustrated in FIG. 1;

FIG. 3 is a diagram illustrating signal lines of signals input to the pixels illustrated in FIG. 2;

FIG. 4 is a schematic diagram illustrating an organic light emitting circuit (R) illustrated in FIG. 3;

FIG. 5 is a timing chart illustrating changes in signals controlled to emit light from an organic EL element;

FIG. 6 is a timing chart illustrating a horizontal synchronizing signal and changes in signals;

FIG. 7 is a timing chart illustrating changes in signals in a first modified example of the first embodiment of the present invention;

FIG. 8 is a timing chart illustrating changes in signals in a second modified example of the first embodiment of the present invention;

FIG. 9 is a schematic diagram illustrating a TFT substrate of an organic EL display device according to a second embodiment of the present invention;

FIG. 10 is a diagram illustrating signal lines of signals input to the pixels illustrated in FIG. 9;

FIG. 11 is a schematic diagram illustrating an organic light emitting circuit (R) illustrated in FIG. 10;

FIG. 12 is a timing chart illustrating changes in signals controlled to emit light from an organic EL element;

FIG. 13 is a timing chart illustrating a horizontal synchronizing signal and changes in signals;

FIG. 14 is a timing chart illustrating changes in signals in a case where three kinds of light emission control signals are used; and

FIG. 15 is a timing chart illustrating changes in signals in a case where one kind of light emission control signal is used.

### DETAILED DESCRIPTION OF THE INVENTION

Hereinafter, first and second embodiments of the present invention are described with reference to the drawings. In the drawings, the same or similar constituent elements are expressed by the same reference numerals, and thus the duplicated descriptions thereof are omitted.

### First Embodiment

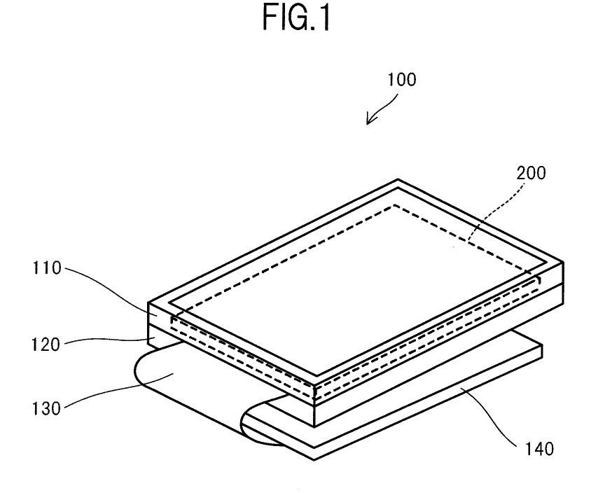

FIG. 1 is a diagram illustrating an organic EL display device 100 according to the first embodiment of the present invention. As illustrated in FIG. 1, the organic EL display device 100 includes a thin film transistor (TFT) substrate 200, an upper frame 110, a lower frame 120, a circuit substrate 140, and a flexible substrate 130. The upper frame 110 and the lower frame 120 are provided to sandwich and fix an organic EL panel including the TFT substrate 200 and a sealing substrate (not shown). The circuit substrate 140 includes circuit elements for generating display information. The flexible substrate 130 is used to transmit the RGB display information generated by the circuit substrate 140 to the TFT substrate 200.

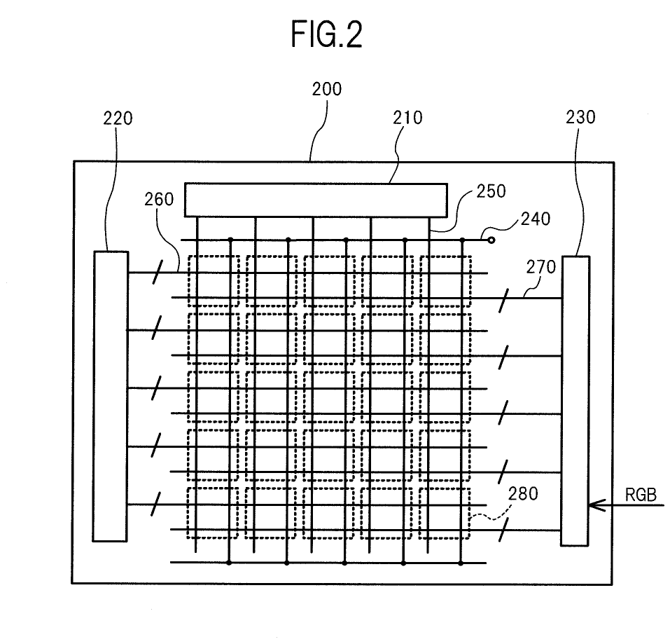

FIG. 2 schematically illustrates the TFT substrate 200 illustrated in FIG. 1. The TFT substrate 200 includes pixels 280, a data signal driving section 210, a gate driving section 220, and a light emission period control signal driving section 230. The pixels 280 are arranged in matrix, each serve as a minimum display unit, and each include pixel electrodes of three kinds of organic light emitting elements for red (R), green (G), and blue (B). The data signal driving section 210 outputs data signals 250 corresponding to display grayscale values to the respective pixels 280. The gate driving section 220 outputs gate signals 260 each having a plurality of signals to control a plurality of TFT switches arranged in each of the pixels 280. The light emission period control signal driving section 230 outputs light emission period control signals 270 each having a rectangular wave to the pixel electrodes to emit light. The number of pixels 280 in FIG. 2 is reduced and is simplified so as not to be complicated.

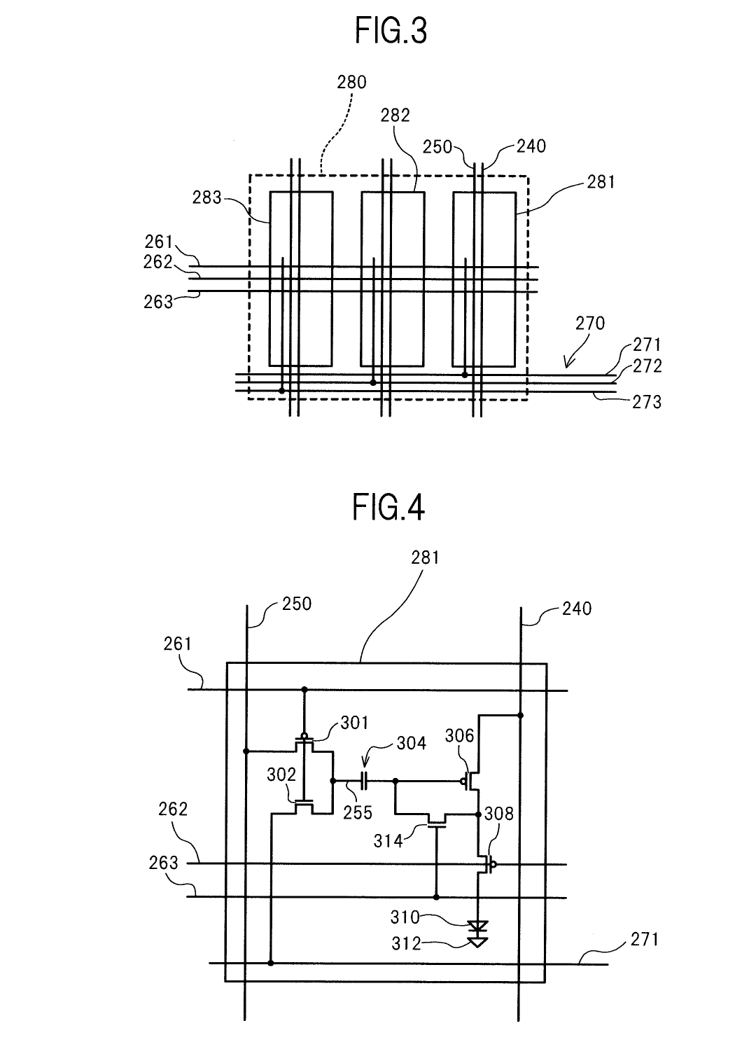

FIG. 3 is a diagram illustrating signal lines for signals input to one of the pixels 280. The pixel 280 includes an organic light emitting circuit (R) 281, an organic light emitting circuit (G) 282, and an organic light emitting circuit (B) 283, which each are a circuit including an organic light emitting element for corresponding light emission color. A signal selection signal 261, a light emission control signal 262, and a reset signal 263, which are included in the gate signal 260 output from the gate driving section 220, are input to the organic light emitting circuits. A power supply voltage 240 and the data signal 250 are input to each of the organic light emitting circuits. A light emission period control signal (R) 271, a light emission period control signal (G) 272, and a light emission period control signal (B) 273, which are included in the light emission period control signal 270 are input to the organic light emitting circuit (R) 281, the organic light emitting circuit (G) 282, and the organic light emitting circuit (B) 283, respectively.

FIG. 4 schematically illustrates the organic light emitting circuit (R) 281. As illustrated in FIG. 4, the organic light emitting circuit (R) 281 includes an organic EL element 310 which is a self-emitter, a first selection switch 301, a second selection switch 302, an organic EL driving TFT 306, a storage capacitor 304, a reset switch 314, a light emission control switch 308, and a common electrode 312. The first selection switch 301 and the second selection switch 302 are used to select one of the light emission period control signal (R) 271 and the data signal 250 which is to be input to an input signal line 255. The organic EL driving TFT 306 serves as a switch for emitting light from the organic EL element 310 and a drain side thereof is connected to an anode side of the organic EL element 310 through the light emission control switch 308 described later. The storage capacitor 304 is provided between the selection switches 301-302 and a gate side of the organic EL driving TFT 306. The reset switch 314 is provided to connect the drain side and gate side of the organic EL driving TFT 306 and operates in response to the reset signal 263. The light emission control switch 308 is located on the drain side of the organic EL driving TFT 306 and driven in response to the light emission control signal 262. The common electrode 312 is connected to a cathode side of the organic EL element 310. A source side of the organic EL driving TFT 306 is connected to the power supply line 240.

Each of the first selection switch 301, the organic EL driving TFT 306, and the light emission control switch 308 includes a p-type MOS transistor, and thus is turned on when a gate signal is in a Low level. On the other hand, each of the second selection switch 302 and the reset signal 314 includes an n-type MOS transistor, and thus is turned on when a gate signal is in a High level.

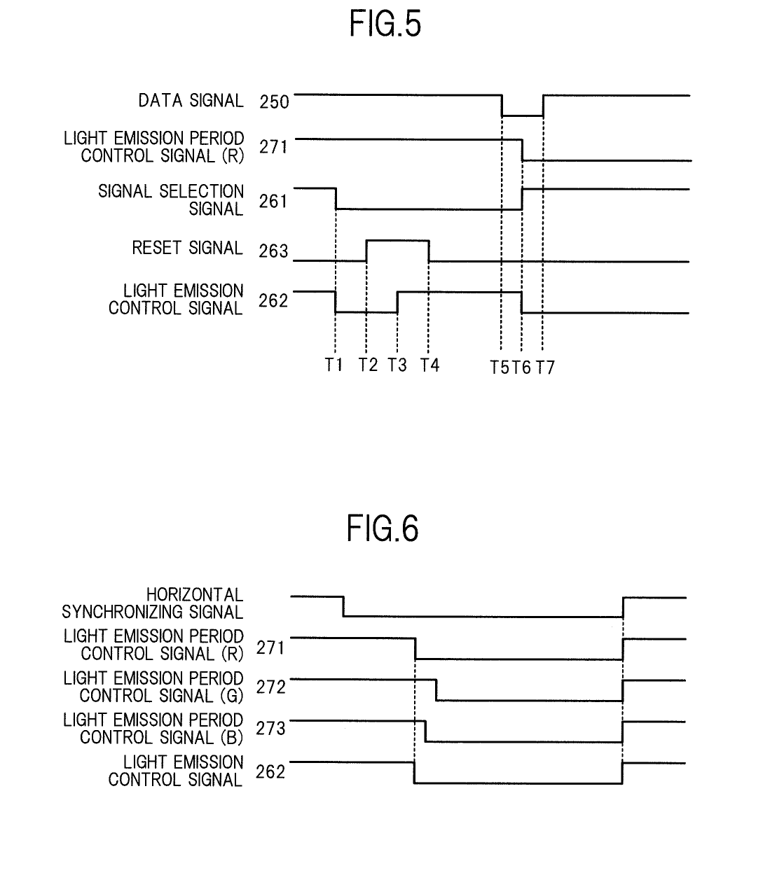

FIG. 5 is a timing chart illustrating changes in signals controlled to emit light from the organic EL element 310 illustrated in FIG. 4. The timing chart illustrates changes in signals which include the data signal 250, the light emission period control signal 271, the signal selection signal 261, the reset signal 263, and the light emission control signal 262, which are illustrated in FIG. 4.

As illustrated in FIG. 5, at a time T1, the signal selection signal 261 becomes a Low level and the light emission control signal 262 becomes a Low level (active). Then, the first selection switch 301 illustrated in FIG. 4 is turned on and the second selection switch 302 is turned off, and hence the data signal 250 is input to the input signal line 255. In addition, the light emission control switch 308 is turned on. The reset signal 263 at the time T1 is in a Low level (negative), and hence the reset switch 314 is in an off state.

Subsequently, at a time T2, the reset signal 263 becomes a High level (active), and hence the reset switch 314 is turned on. Then, the gate and drain of the organic EL driving TFT 306 are electrically connected to each other. Therefore, a current flows from the power supply line 240 to the common electrode 312 through the organic EL driving TFT 306 being diode-connected.

Next, at a time T3, when the light emission control signal 262 becomes a High level (negative), the light emission control switch 308 is turned off and a gate voltage of the organic EL driving TFT 306 increases. Then, when the gate voltage reaches a threshold voltage of the organic EL driving TFT 306, the organic EL driving TFT 306 is turned off. Next, at a time T4, the reset signal 263 is set to a Low level (negative) to turn off the reset switch 314.

Next, at a time T5, data corresponding to a grayscale value is input as the data signal 250. Then, the signal input to the input signal line 255 is pulled down to a voltage of the data corresponding to the grayscale value. With the pulling down of the signal, the gate voltage of the organic EL driving TFT 306 is also pulled down through the storage capacitor 304. Therefore, a current corresponding to the data flows from the source side to the gate side, to set the amount of charges corresponding to the grayscale value.

Next, at a time T6, the signal selection signal 261 is set to a High level, a light emission period control voltage is set as the light emission period control signal (R) 271, the light emission control signal 262 becomes a Low level (active). Then, the first selection switch 301 is turned off and the second selection switch 302 is turned on, and hence the light emission period control signal (R) 271 is input to the input signal line 255. In addition, the light emission control switch 308 is turned on. As a result, a voltage corresponding to the voltage of the light emission period control signal applied to the input signal line 255 is generated on the gate side of the organic EL driving TFT 306 and thus a current flows into the gate side. Therefore, a current flows from the source side of the organic EL driving TFT 306 to the drain side thereof to emit light from the organic EL element 310.

When a Low (active) period of the light emission period control signal (R) 271 is adjusted, the entire image may be darkened or lightened. Therefore, when this fact is used, a high-luminance mode for outdoor use and a low-luminance mode for indoor use or reduction in power consumption may be realized without changing the voltage of the data signal 250 which is the signal based on the grayscale value. That is, in the case of the high-luminance mode, the Low (active) period is lengthened. In the case of the low-luminance mode, the Low (active) period is shortened. Thus, the respective modes may be realized. The present invention is not limited to the case where the luminance mode is set by a user. The luminance mode may be automatically adjusted based on an external environment, for example, brightness of outside light or an operating duration.

In contrast to this, as illustrated in FIG. 3, the light emission period control signal (R) 271, the light emission period control signal (G) 272, and the light emission period control signal (B) 273 are independent from each other. Therefore, the light emission period control voltage or the light emission period control period (Low (active) period) may be changed for each color to adjust a color balance without depending on the luminance mode. The color balance may be adjusted based on the data signals 250.

FIG. 6 is a timing chart illustrating a horizontal synchronizing signal which is one of video signals and changes in signals which include the light emission period control signal (R) 271, the light emission period control signal (G) 272, the light emission period control signal (B) 273, and the light emission control signal 262. Assume that the display device is operated with the low-luminance mode in view of power saving. In this case, an end of the Low (active) period of each of the light emission period control signals 271 to 273 coincides with an end of the horizontal synchronizing signal. Of the light emission period control signals 271 to 273, the light emission period control signal (R) 271 has a maximum Low (active) period. The Low (active) period of the light emission period control signal (G) 272 is 80% of the Low (active) period of the light emission period control signal (R) 271. The Low (active) period of the light emission period control signal (B) 273 is 95% of the Low (active) period of the light emission period control signal (R) 271.

The Low (active) period of the light emission control signal 262 is controlled so that the light emission control signal 262 is synchronized with the light emission period control signal (R) 271 having the maximum active period.

Therefore, in this embodiment, the light emission control signal 262 is synchronized with the light emission period control signal (R) 271 having the maximum active period, and hence light emission which may be caused by a very small current flowing particularly during a non-light emission period in the low-luminance mode may be suppressed. Thus, a high contrast may be achieved and current consumption may be reduced.

The inventors of the present invention conducted research with subjects. As a result, the inventors have found that, when the light emission periods for the respective colors are different from one another and the light emission periods for all the colors are equal to or larger than 80% of the maximum light emission period, phenomena such as color break-up and flicker are not recognized. In this embodiment, the active period of the light emission period control signal (G) 272 and the active period of the light emission period control signal (B) 273 are controlled to be equal to or larger than 80% of the Low (active) period of the light emission period control signal (R) 271 which is the light emission period control signal having the maximum active period. Therefore, in this embodiment, even in the case of the low-luminance mode, phenomena such as color break-up and flicker may be suppressed.

When the high-contrast low-luminance mode is realized as described above, power consumption may be suppressed and the life of the organic EL element 310 may be lengthened.

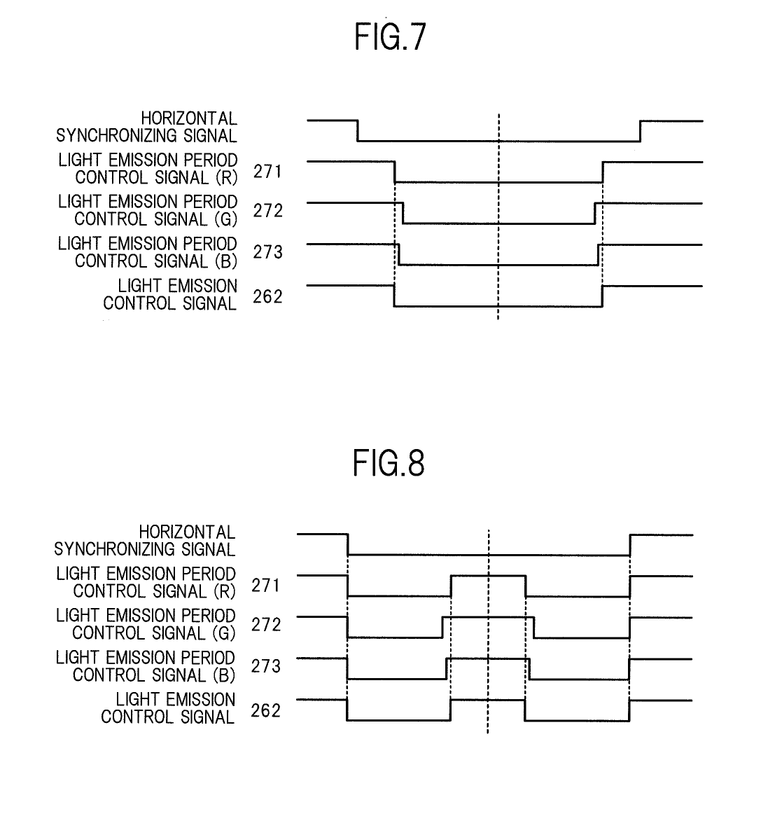

FIG. 7 illustrates a first modified example of the first embodiment and is a timing chart corresponding to the timing chart illustrated in FIG. 6. In this timing chart, the middle of the Low (active) period of each of the light emission period control signals 271 to 273 coincides with the middle of the horizontal synchronizing signal, and the total length of the Low (active) period of each of the light emission period control signals 271 to 273 is equal to the length in the case of the timing chart illustrated in FIG. 6. The Low (active) period of the light emission control signal 262 is controlled to be synchronized with the light emission period control signal (R) 271 having the maximum active period, as in the case of the timing chart illustrated in FIG. 6.

Even when the timings as described above are set, because the light emission control signal 262 is synchronized with the light emission period control signal (R) 271 having the maximum active period as in the first embodiment, light emission which may be caused by a very small current flowing during the non-light emission period in the low-luminance mode may be suppressed, and hence a high contrast may be achieved and current consumption may be reduced.

Also in this modified example, the active period of the light emission period control signal (G) 272 and the active period of the light emission period control signal (B) 273 are controlled to be equal to or larger than 80% of the Low (active) period of the light emission period control signal (R) 271 which is the light emission period control signal having the maximum active period. Therefore, phenomena such as color break-up and flicker may be suppressed.

When the low-luminance mode in which the contrast is high and phenomena such as color break-up and flicker are suppressed is realized as described above, power consumption may be suppressed and the life of the organic EL element 310 may be lengthened.

FIG. 8 illustrates a second modified example of the first embodiment and is a timing chart corresponding to the timing chart illustrated in FIG. 6. In this timing chart, the Low (active) period of each of the light emission period control signals 271 to 273 is divided into two periods. A start of one of the divided periods coincides with a start of the horizontal synchronizing signal. An end of the other of the divided periods coincides with the end of the horizontal synchronizing signal. The Low (active) period of the light emission control signal 262 is controlled to be synchronized with the light emission period control signal (R) 271 having the maximum active period, as in the case of the timing chart illustrated in FIG. 6.

Even when the timings as described above are set, because the light emission control signal 262 is synchronized with the light emission period control signal (R) 271 having the maximum active period as in the first embodiment, light emission which may be caused by a very small current flowing during the non-light emission period in the low-luminance mode may be suppressed, and hence a high contrast may be achieved and current consumption may be reduced.

Also in this modified example, the active period of the light emission period control signal (G) 272 and the active period of the light emission period control signal (B) 273 are controlled to be equal to or larger than 80% of the Low (active) period of the light emission period control signal (R) 271 which is the light emission period control signal having the maximum active period. Therefore, phenomena such as color break-up and flicker may be suppressed.

When the low-luminance mode in which the contrast is high and phenomena such as color break-up and flicker are suppressed is realized as described above, power consumption may be suppressed and the life of the organic EL element 310 may be lengthened.

In the second modified example, the light emission period is divided into two periods, and hence a light emission frequency becomes higher. Therefore, phenomena such as color break-up and flicker may be further suppressed.

### Second Embodiment

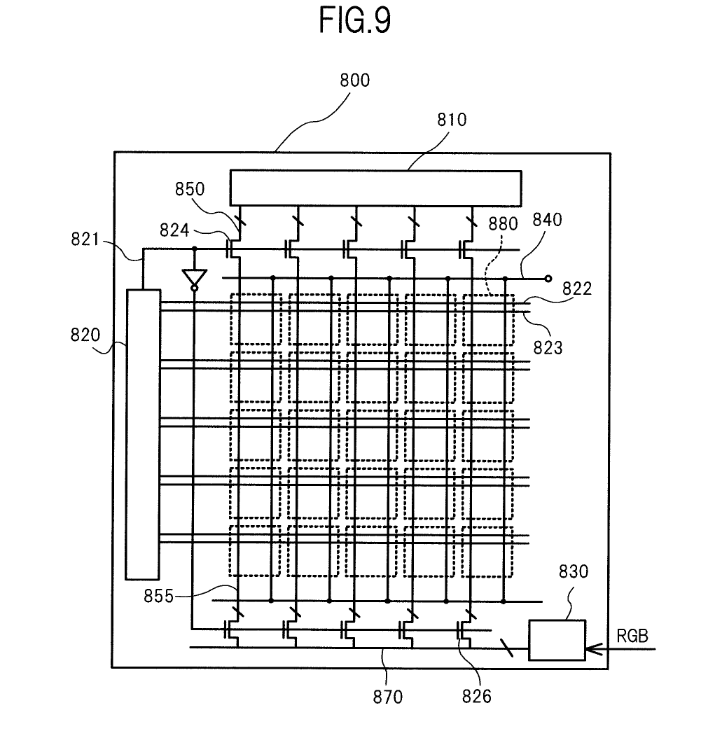

FIG. 9 schematically illustrates a TFT substrate 800 according to a second embodiment of the present invention. An organic EL display device containing the TFT substrate 800 has the same structure as the organic EL display device 100 according to the first embodiment as illustrated in FIG. 1.

The TFT substrate 800 includes pixels 880, a data signal driving section 810, a gate driving section 820, a light emission period control signal driving section 830, first selection switches 824, and second selection switches 826. The pixels 880 are arranged in matrix, each serve as a minimum display unit, and each have pixel electrodes of organic light emitting elements for red (R), green (G), and blue (B). The data signal driving section 810 outputs data signals 850 corresponding to display grayscale values to the respective pixels 880. The gate driving section 820 outputs signals for controlling a plurality of TFT switches arranged in each of the pixels 880. The light emission period control signal driving section 830 outputs light emission period control signals 870 each having a rectangular wave to the pixel electrodes to emit light. Each of the first selection switches 824 and each of the second selection switches 826 are used to select one of the light emission period control signal 870 and the data signal 850 which is to be input as an input signal 855, based on a signal selection signal 821. The number of pixels 880 in FIG. 9 is reduced and is simplified so as not to be complicated, as in the case of FIG. 2 in the first embodiment.

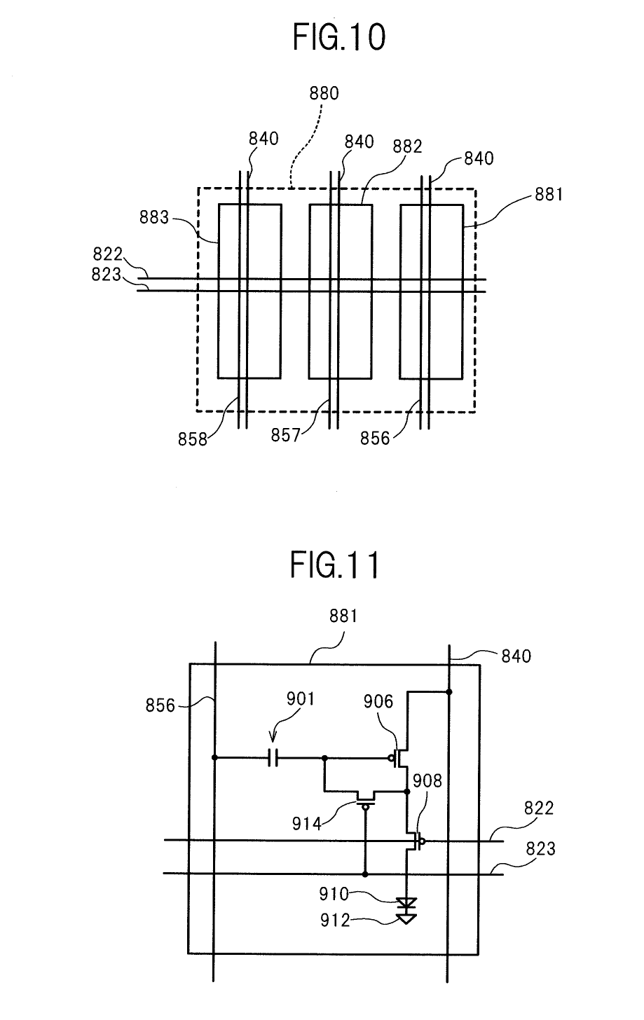

FIG. 10 illustrates signal lines for signals input to one of the pixels 880. The pixel 880 includes an organic light emitting circuit (R) 881, an organic light emitting circuit (G) 882, and an organic light emitting circuit (B) 883, which each are a circuit including an organic light emitting element for corresponding light emission color. A light emission control signal 822 and a reset signal 823, which are included in the gate signal output from the gate driving section 820, are input to the organic light emitting circuits. A power supply voltage 840 is input to each of the organic light emitting circuits.

An input signal (R) 856, an input signal (G) 857, and an input signal (B) 858, which are included in the input signal 855, are input to the organic light emitting circuit (R) 881, the organic light emitting circuit (G) 882, and the organic light emitting circuit (B) 883, respectively. The data signal (R) 851, the data signal (G) 852, and the data signal (B) 853 which are included in the data signal 850, or a light emission period control signal (R) 871, a light emission period control signal (G) 872, and a light emission period control signal (B) 873 which are included in the light emission period control signal 870 are input as the input signal (R) 856, the input signal (G) 857, and the input signal (B) 858 based on a switched selection signal.

FIG. 11 schematically illustrates the organic light emitting circuit (R) 881. As illustrated in FIG. 11, the organic light emitting circuit (R) 881 includes an organic EL element 910 which is a self-emitter, an organic EL driving TFT 906, a storage capacitor 901, a reset switch 914, a light emission control switch 908, and a common electrode 912. The organic EL driving TFT 906 serves as a switch for driving the organic EL element 910 and a drain side thereof is connected to an anode side of the organic EL element 910 through the light emission control switch 908 described later. The storage capacitor 901 is provided on a gate side of the organic EL driving TFT 906. The reset switch 914 is provided to connect the drain side and gate side of the organic EL driving TFT 906 and operates in response to the reset signal 823. The light emission control switch 908 is located on the drain side of the organic EL driving TFT 906 and driven in response to the light emission control signal 822. The common electrode 912 is connected to a cathode side of the organic EL element 910. A source side of the organic EL driving TFT 906 is connected to the power supply line 840.

Each of the organic EL driving TFT 906, the light emission control switch 908, and the reset switch 914 includes a p-type MOS transistor, and thus is turned on when a gate signal is in a Low level.

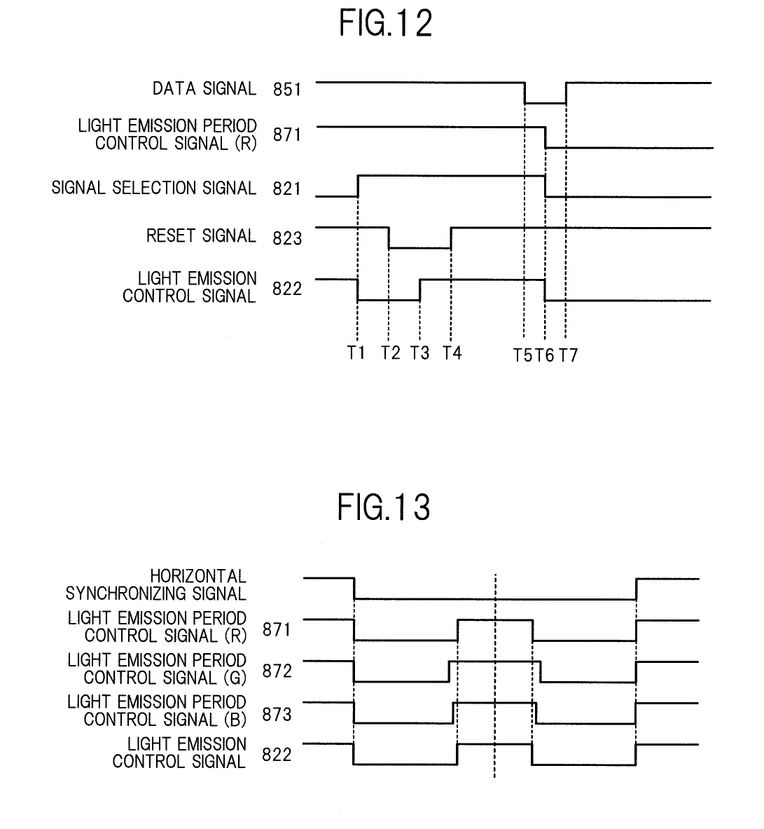

FIG. 12 is a timing chart illustrating changes in signals controlled to emit light from the organic EL element 910 illustrated in FIG. 11. Unlike the reset switch 314 in the first embodiment, the reset switch 914 in this second embodiment includes a p-type MOS transistor. Therefore, in this timing chart, the reset signal 823 has reversed Low and High states. A signal selection signal 821 also has reversed Low and High states. The other points are the same as the timing chart in the first embodiment as illustrated in FIG. 5 and the same operation is performed, and hence the description thereof is omitted.

FIG. 13 is a timing chart illustrating a horizontal synchronizing signal which is one of video signals and changes in the light emission period control signal (R) 871, the light emission period control signal (G) 872, the light emission period control signal (B) 873, and the light emission control signal 822. In this timing chart, as in the case of the timing chart illustrated in FIG. 8, the Low (active) period of each of the light emission period control signals 871 to 873 is divided into two periods. The start of one of the divided periods coincides with the start of the horizontal synchronizing signal. The end of the other of the divided periods coincides with the end of the horizontal synchronizing signal. The Low (active) period of the light emission control signal 822 is controlled so that the light emission control signal 822 is synchronized with the light emission period control signal (R) 871 having the maximum active period.

Even when the timings as described above are set, because the light emission control signal 822 is synchronized with the light emission period control signal (R) 871 having the maximum active period as in the first embodiment, light emission which may be caused by a very small current flowing during the non-light emission period in the low-luminance mode may be suppressed, and hence a high contrast may be achieved and current consumption may be reduced.

Also in this embodiment, the active period of the light emission period control signal (G) 872 and the active period of the light emission period control signal (B) 873 are controlled to be equal to or larger than 80% of the Low (active) period of the light emission period control signal (R) 871 which is the light emission period control signal having the maximum active period. Therefore, phenomena such as color break-up and flicker may be suppressed.

Even in the low-luminance mode as described above, when the low-luminance mode in which the contrast is high and phenomena such as color break-up and flicker are suppressed is realized, power consumption may be suppressed and the life of the organic EL element 910 may be lengthened.

The light emission period is divided into two periods, and hence a light emission frequency becomes higher. Therefore, phenomena such as color break-up and flicker may be further suppressed.

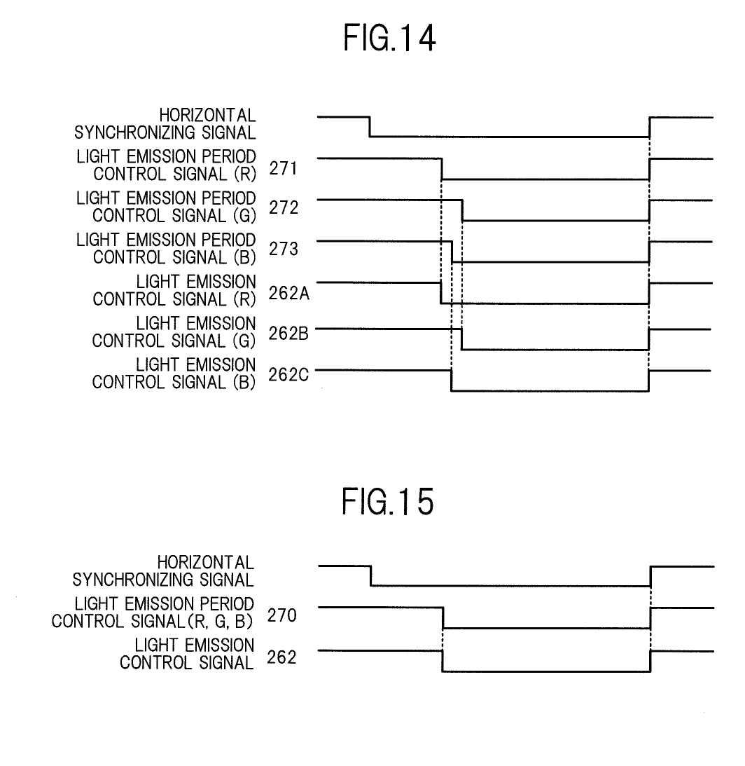

In each of the first embodiment and the second embodiment, the light emission period control signal is divided into the three kinds of signals for R, G, and B and the one kind of light emission control signal is set. However, as illustrated in FIG. 14, three kinds of light emission control signals 262A, 262B and 262C may be set for R, G, and B, provided with active periods which coincide with the active periods of the respective light emission period control signals, and synchronized therewith for operation.

In contrast to this, even in a case where one kind of light emission period control signal 270 is set, as illustrated in FIG. 15, when a light emission control signal is provided with an active period which coincides with the active period of the light emission period control signal and synchronized therewith for operation, the present invention may be applied.

In each of the second modified example of the first embodiment and the second embodiment, the period of the light emission period control signal is divided into the two periods, but may be divided into three or more periods.

In the first embodiment and the second embodiment, the circuits as illustrated in FIGS. 2 to 4 and FIGS. 9 to 11 are used. However, the present invention is not limited to such circuit structures and may be applied to a display device using a self-light emitting element for emitting light based on a light emission period control voltage.

Although not described in the first embodiment and the second embodiment, a light emission material used for an organic EL layer may be a low-molecular material or a polymer material. A type of the organic EL panel which is associated with a light extraction direction may be any of a bottom emission type and a top emission type. A self-emitter different from the organic EL element may be used.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device, comprising:
a plurality of pixels which hold voltages based on grayscale values and each include:
a light emitting element for emitting light for display when a light emission period control voltage which is a voltage of a light emission period control signal is applied to corresponding one of the plurality of pixels;
a light emitting element driving transistor which operates as a switch for supplying a current based on corresponding one of the grayscale values in response to applying the light emission period control voltage; and
a light emission control switch transistor which electrically connects between the light emitting element and the light emitting element driving transistor;
a light emission period control signal driving section for controlling the light emitting element driving transistor; and
a gate signal driving section for generating a light emission control signal to be input to a gate line of the light emission control switch transistor,
wherein the gate signal driving section synchronizes the light emission control signal with the light emission period control signal.

2. The image display device according to claim 1, wherein:
each of the plurality of pixels includes a plurality of the light emitting elements having different light emission colors;
the plurality of the light emitting elements have different application periods of the light emission period control voltage; and
the gate signal driving section synchronizes the light emission control signal with the light emission period control signal having a maximum application period among the application periods of the light emission period control voltage.

3. The image display device according to claim 1, wherein the light emission period control signal driving section controls the light emission period control signal to synchronize an end of an application period of the light emission period control voltage with an end of a horizontal synchronizing signal.

4. The image display device according to claim 1, wherein the light emission period control signal driving section controls the light emission period control signal to match a center of an application period of the light emission period control voltage with a center of a horizontal synchronizing signal.

5. The image display device according to claim 1, wherein the light emission period control signal driving section divides an application period of the light emission period control voltage into a plurality of application periods.

6. The image display device according to claim 5, wherein
the light emission period control signal driving section divides the application period of the light emission period control voltage into a first application period and a second application period, synchronizes a start of the first application period with a start of a horizontal synchronizing signal for display on the image display device, and synchronizes an end of the second application period with an end of the horizontal synchronizing signal.

7. The image display device according to claim 1, wherein:
each of the plurality of pixels includes a plurality of the light emitting elements having different light emission colors;
the plurality of the light emitting elements have different application periods of the light emission period control voltage; and
the light emission period control signal driving section controls application periods for light emitting elements other than a light emitting element having a maximum application period among the application periods so as to an application period equal to or larger than a predetermined percentage of the maximum application period.

8. The image display device according to claim 7, wherein the predetermined percentage is 80%.
